(19) United States
(12) Patent Application Publication
(10) Pub. No.: US 2002/0007422 A1
(43) Pub. Date: Jan. 17, 2002

(54) Providing equipment access to supply chain members

(76) Inventor: Keith E. Bennett, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/896,337

(22) Filed: Jun. 28, 2001

Related U.S. Application Data
(63) Continuation-in-part of application No. 09/611,967, filed on Jul. 6, 2000.
(60) Provisional application No. 60/216,764, filed on Jul. 6, 2000.

(51) Int. Cl. G06F 15/16

(52) U.S. Cl. 709/246

(57) ABSTRACT

A services coordinator provides access to a piece of equipment to a supply chain member with interest in the piece of equipment. The services coordinator is coupled to an equipment overlay network, which includes an equipment server that is coupled to the piece of equipment to manage concurrent accesses to the piece of equipment. The supply chain member is coupled to the services coordinator to communicate with the piece of equipment through an application that is coupled to the equipment server.

### RELATED APPLICATIONS

This application is a continuation-in-part of U.S. patent application Ser. No. 09/611,967 and claims the benefit of U.S. Provisional Patent Application No. 60/216,764, both filed on Jul. 6, 2000.

### FIELD OF THE INVENTION

This invention relates generally to equipment monitoring and/or control, and more particularly to providing access to the equipment for supply chain members.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright ©1998, Symphony Systems, All Rights Reserved.

### BACKGROUND OF THE INVENTION

Many equipment users monitor and/or control the operation of equipment through an equipment control system. As illustrated in FIG. 1A, one variation of an equipment control system 101 couples the equipment 107, 109 directly to a control computer 103. FIG. 1B illustrates another equipment control system 111 that couples equipment 119, 121 to a controller 117. The controller 117 may be further connected to a control computer 113 as shown in FIG. 1B.

The computer/controller hosts various software equipment applications 105, 115 that determine the status of the equipment by sending information requests to the equipment and receiving the status information in return. When the equipment is capable of being programmed, an equipment application may also issue commands to change the operation of the equipment.

Existing application software products use architectures and technologies derived from mainframe computing and client-server architectures. The most prevalent architecture treats the equipment as slaves to the application executing on the computer/controller. In these host-slave architectures, the equipment can only communicate with a single host application. This results in severely limited application capability and extremely high systems integration costs.

To provide the range of applications and services that customers require, companies have created application suites with a variety of functional modules. Providing access to the equipment for the applications from one vendor concurrently with access for applications from another vendor requires customized system integration. Integrating systems across supply chains has been even more difficult. For example, it is impractical today for an equipment manufacturer to provide an equipment health monitoring and maintenance application that operates in parallel with the equipment user's manufacturing execution system.

Equipment applications require an “equipment driver” for each kind of equipment. For example, an automated process system utilizes programmable logic controllers to control a plant. Typically, equipment communicates by a protocol specific to each type of equipment, and a different driver must be created for each type of equipment for each application. Developing the device drivers is both time-consuming and expensive, and limits the application market. The telecommunications industry has partially addressed this issue by requiring implementation of SNMP (Simple Network Management Protocol) on all equipment—thus making SNMP a “native” equipment protocol—so that SNMP applications can control the equipment. In the semiconductor manufacturing market, Brookside Software has created a solution for monitoring equipment health using a “pass-through” architecture that allows both a Brookside application and a host application to communicate with the equipment, but does not open up access to the equipment to other applications.

When the controllers understand multiple different equipment protocols, the use of the controller can isolate an equipment application from the unique characteristics of the underlying equipment. However, an equipment control system configured with controllers does not completely ease the burden of creating new applications because an application must be able to interface with each type of available controller and changes must be made to each installed controller to support any new functions required by the new application.

Furthermore, multiple applications may need concurrent access to the equipment, a capability that is not provided by the prior art equipment monitoring and control systems.

The ability to rapidly optimize and increase the productivity of equipment in a dynamic environment is more important than ever in the current global market. Because typically the equipment control systems are internal to a facility, a person at another facility or in another organization has little or no access to the equipment and thus cannot determine its status or make operational changes to improve its performance. This isolation also limits valuable electronic collaboration between the various vendors and suppliers that provide, service and maintain the equipment. It is difficult, for example, for an equipment manufacturer to deploy an application for equipment health monitoring for their equipment at a variety of different customers because the costs of integrating the equipment monitoring application with each of their customer's applications is very expensive. Similarly, it would be very difficult for a supply chain vendor that provides consumable supplies for the equipment to deploy an application monitoring consumption of the consumable and automatically provide a replacement at the appropriate time.

As an alternative solution, and to avoid system integration requirements, equipment manufacturers have created and provided their own proprietary interfaces and communications mechanisms to communicate with their equipment. For example, a semiconductor equipment manufacturer, KLA-Tencor, previously provided a modem connection to their tool along with a serial protocol for diagnostics and has recently developed their own interface and communications protocol communicating via a network interface. KLA-Tencor also provides their own applications hosted remotely from the equipment for equipment diagnostics.

Currently, each supply chain member makes use of a particular interface into the equipment and generally communicates to the equipment through a particular protocol, and must independently deploy, administrate, and manage all of the elements (application creation/purchasing, information systems management, and implementation of the interfaces or protocols required.)

Therefore, there is a need to integrate existing equipment into secure, distributed applications that permit shared equipment access irrespective of facility, organizational, or geographical boundaries.

### SUMMARY OF THE INVENTION

The above-mentioned shortcomings, disadvantages and problems are addressed by the present invention, which will be understood by reading and studying the following specification.

A services coordinator provides access to a piece of equipment to a supply chain member with interest in the piece of equipment. The services coordinator is coupled to an equipment overlay network, which includes an equipment server that is coupled to the piece of equipment to manage concurrent accesses to the piece of equipment. The supply chain member is coupled to the equipment overlay network through the services coordinator to communicate with the equipment through an application that is coupled to the equipment server.

In one aspect, the services coordinator receives compensation from the supply chain member for the access. In another aspect, the supply chain member is specified as the services coordinator and controls its own access to the equipment. In a further aspect, the application may be remotely coupled to the equipment server through the services coordinator or another application may be remotely coupled to the equipment overlay network through the services coordinator to control the application.

By providing access to equipment to multiple members of the supply chain community, the services coordinator enables an innovative and economically efficient mechanism for individuals and organizations to work independently as well as collaborate to increase the productivity and value of equipment. For example, equipment manufacturers can remotely diagnose and service equipment, or an application provider can distribute an application for use by an equipment user without requiring specific system integration and customization to each user's information system. For another example, an equipment manufacturer can easily deploy an identical application for use with their equipment at multiple customer sites without interfacing to each user's information system. Moreover, the equipment manufacturer's application could be deploy and managed remotely from the equipment, and independently from the equipment user's information system.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIGS. 1A and 1B are diagrams of embodiments of prior art equipment control systems;

FIG. 2A is a diagram of one embodiment of an operating environment suitable for practicing the present invention;

FIG. 2B is a diagram of one embodiment of a computer system suitable for use in the operating environment of FIG. 2A;

FIG. 3A is a diagram of one embodiment of an equipment overlay network architecture according to the present invention;

FIG. 3B is a diagram of one embodiment of an equipment server for the equipment overlay network architecture of FIG. 3A;

FIGS. 4A-C are flowcharts of one embodiment of methods performed by the equipment server of FIG. 3B;

FIG. 4D is a flowchart of one embodiment of a method performed by a services coordinator according to the present invention; and

FIG. 5 is a diagram of a security hierarchy used in a particular implementation of the invention.

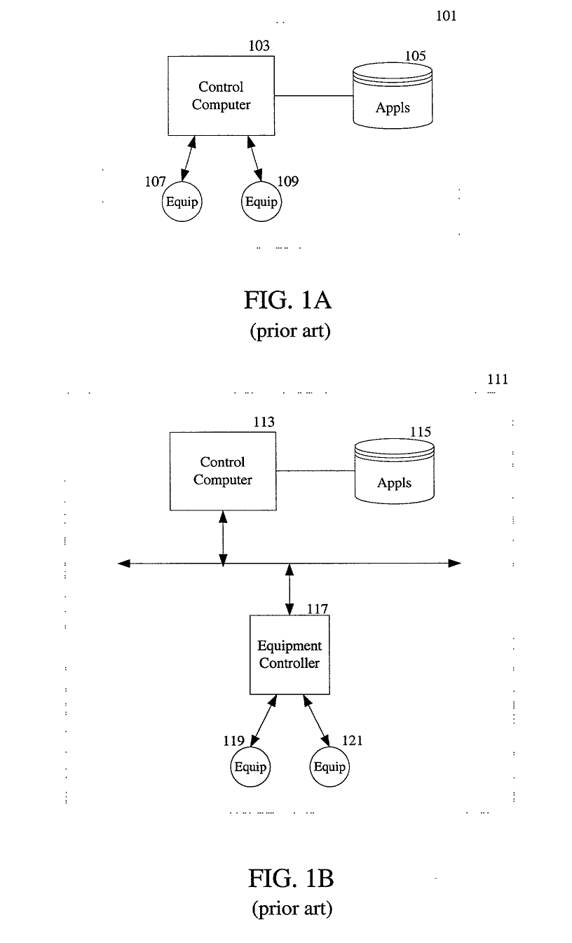

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

The detailed description is divided into five sections. In the first section, the hardware and the operating environment in conjunction with which embodiments of the invention may be practiced are described. In the second section, an overview of an equipment overlay network architecture according to one embodiment of the invention is presented. In the third section, an embodiment of a method performed by a computer in the equipment overlay network is described with reference to a series of flowcharts. In the fourth section, a particular implementation of the invention is presented. Finally, in the fifth section, a conclusion of the detailed description is provided.

### Operating Environment

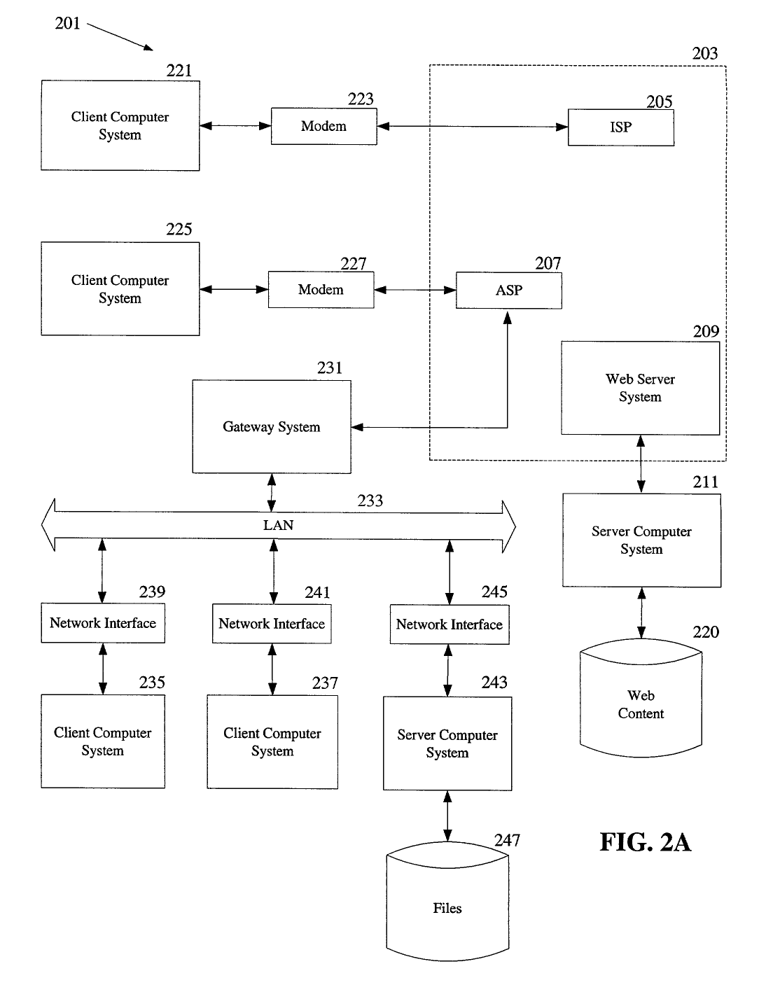

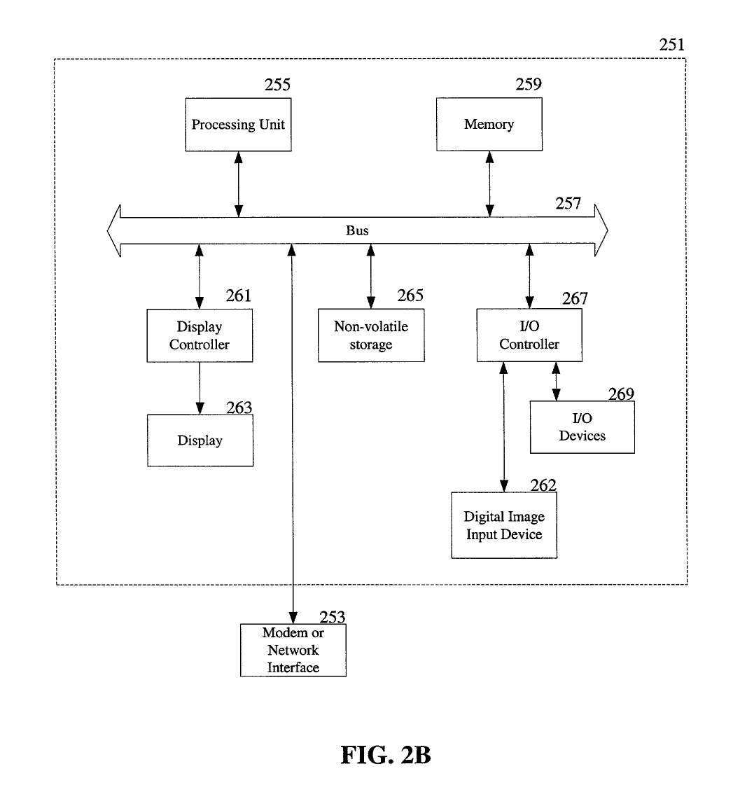

The following description of FIGS. 2A and 2B is intended to provide an overview of computer hardware and other operating components suitable for implementing the invention, but is not intended to limit the applicable environments. One of skill in the art will immediately appreciate that the invention can be practiced with other computer system configurations, including hand-held devices, server appliances, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 2A shows several computer systems that are coupled together through a network 203, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 203 is typically provided by Internet service providers (ISP), such as the ISP 205, and application service providers, such as ASP 207. Users on client systems, such as client computer systems 221, 225, 235, and 237 obtain access to the Internet through the service providers, such as ISP 205 and ASP 207. Access to the Internet allows users of the client computer systems to exchange information, receive and send e-mails, and view documents, such as documents which have been prepared in the HTML format. These documents are often provided by web servers, such as web server 209 which is considered to be “on” the Internet. Often these web servers are provided by the ISPs, such as ISP 205, although a computer system can be set up and connected to the Internet without that system being also an ISP as is well known in the art.

The web server 209 is typically at least one computer system which operates as a server computer system and is configured to operate with the protocols of the World Wide Web and is coupled to the Internet. Optionally, the web server 209 can be part of an ISP or ASP which provides access to the Internet for client systems. The web server 209 is shown coupled to the server computer system 211 which itself is coupled to web content 220, which can be considered a form of a media database. It will be appreciated that while two computer systems 209 and 211 are shown in FIG. 2A, the web server system 209 and the server computer system 211 can be one computer system having different software components providing the web server functionality and the server functionality provided by the server computer system 211 which will be described further below.

Client computer systems 221, 225, 235, and 237 can each, with the appropriate web browsing software, view HTML pages provided by the web server 209. The ISP 205 provides Internet connectivity to the client computer system 221 through the modem interface 223 which can be considered part of the client computer system 221. The client computer system can be a personal computer system, a handheld device, a network computer, a Web TV system, or other such computer system. Similarly, the ASP 207 provides Internet connectivity for client systems 225, 235, and 237, although as shown in FIG. 2, the connections are not the same for these three computer systems. Client computer system 225 is coupled through a modem interface 227 while client computer systems 235 and 237 are part of a LAN. While FIG. 2 shows the interfaces 223 and 227 as generically as a “modem,” it will be appreciated that each of these interfaces can be an analog modem, ISDN modem, cable modem, satellite transmission interface (e.g. “Direct PC”), or other interfaces for coupling a computer system to other computer systems. Client computer systems 235 and 237 are coupled to a LAN 233 through network interfaces 239 and 241, which can be Ethernet network or other network interfaces. The LAN 233 is also coupled to a gateway computer system 231 which can provide firewall and other Internet related services for the local area network. This gateway computer system 231 is coupled to the ASP 207 to provide Internet connectivity to the client computer systems 235 and 237. The gateway computer system 231 can be a conventional server computer system. Also, the web server system 209 can be a conventional server computer system.

Alternatively, as well-known, a server computer system 243 can be directly coupled to the LAN 233 through a network interface 245 to provide files 247 and other services to the clients 235, 237, without the need to connect to the Internet through the gateway system 231.

While the network 203 has been described in terms of the Internet, the invention is not so limited and the equipment overlay network architecture is equally applicable to Virtual Private Networks (VPNs), proprietary networks, and secure networks that can be separate from, or layered onto, the Internet. Furthermore, the invention encompasses various communication, document and data protocols in addition to those described above.

FIG. 2B shows one example of a conventional computer system that can be used as a client computer system or a server computer system or as a web server system. It will also be appreciated that such a computer system can be used to perform many of the functions of an Internet service provider, such as ISP 205. The computer system 251 interfaces to external systems through the modem or network interface 253. It will be appreciated that the modem or network interface 253 can be considered to be part of the computer system 251. This interface 253 can be an analog modem, ISDN modem, cable modem, token ring interface, satellite transmission interface (e.g. “Direct PC”), or other interfaces for coupling a computer system to other computer systems. The computer system 251 includes a processor 255, which can be a conventional microprocessor such as an Intel Pentium microprocessor or Motorola Power PC microprocessor. Memory 259 is coupled to the processor 255 by a bus 257. Memory 259 can be dynamic random access memory (DRAM) and can also include static RAM (SRAM). The bus 257 couples the processor 255 to the memory 259 and also to nonvolatile storage 265 and to display controller 261 and to the input/output (I/O) controller 267. The display controller 261 controls in the conventional manner a display on a display device 263 which can be a cathode ray tube (CRT) or liquid crystal display. The input/output devices 269 can include a keyboard, disk drives, printers, a scanner, and other input and output devices, including a mouse or other pointing device. The display controller 261 and the I/O controller 267 can be implemented with conventional well known technology. A digital image input device 262 can be a digital camera which is coupled to an I/O controller 267 in order to allow images from the digital camera to be input into the computer system 251. The non-volatile storage 265 is often a magnetic hard disk, an optical disk, or another form of storage for large amounts of data. Some of this data is often written, by a direct memory access process, into memory 259 during execution of software in the computer system 251. One of skill in the art will immediately recognize that the term “computer-readable medium” includes any type of storage device that is accessible by the processor 255 and also encompasses a carrier wave that encodes a data signal.

It will be appreciated that the computer system 251 is one example of many possible computer systems which have different architectures. For example, personal computers based on an Intel microprocessor often have multiple buses, one of which can be considered to be a peripheral bus. Network computers are another type of computer system that can be used with the present invention. Network computers do not usually include a hard disk or other mass storage, and the executable programs are loaded from a network connection into the memory 259 for execution by the processor 255. A Web TV system, which is known in the art, is also considered to be a computer system according to the present invention, but it may lack some of the features shown in FIG. 2B, such as certain input or output devices. A typical computer system will usually include at least a processor, memory, and a bus coupling the memory to the processor.

It will also be appreciated that the computer system 251 is controlled by operating system software which includes a file management system, such as a disk operating system, which is part of the operating system software. One example of an operating system software with its associated file management system software is the operating system known as Windows '95® from Microsoft Corporation of Redmond, Wash., and its associated file management system. The file management system is typically stored in the non-volatile storage 265 and causes the processor 255 to execute the various acts required by the operating system to input and output data and to store data in memory, including storing files on the non-volatile storage 265.

### Equipment Overlay Network Architecture

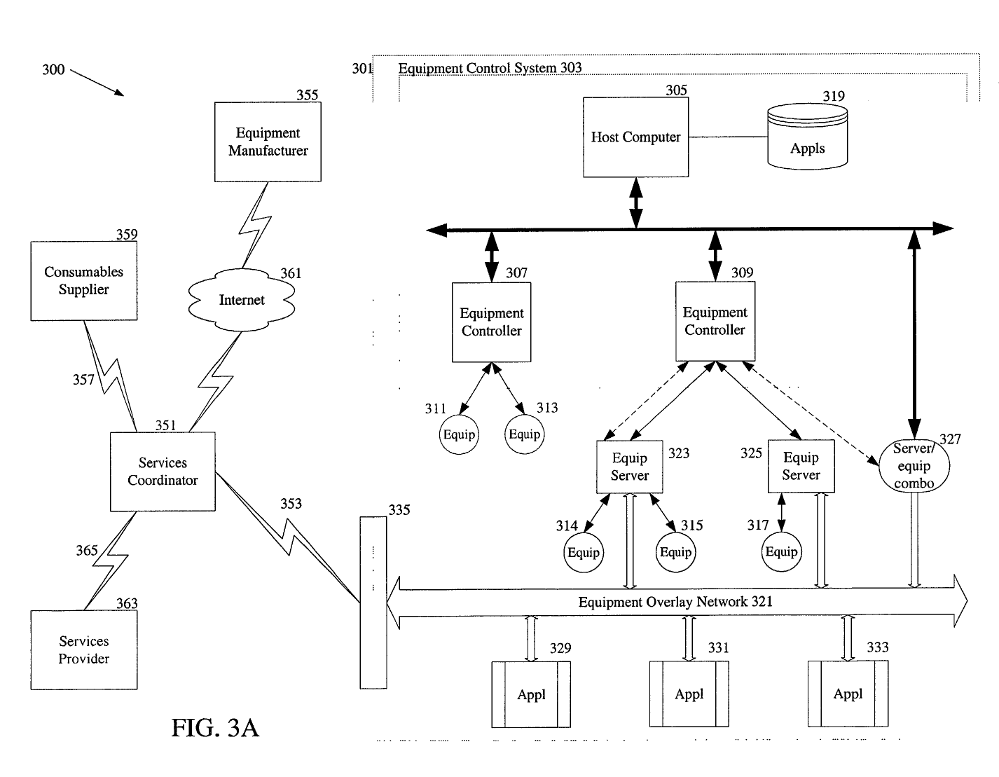

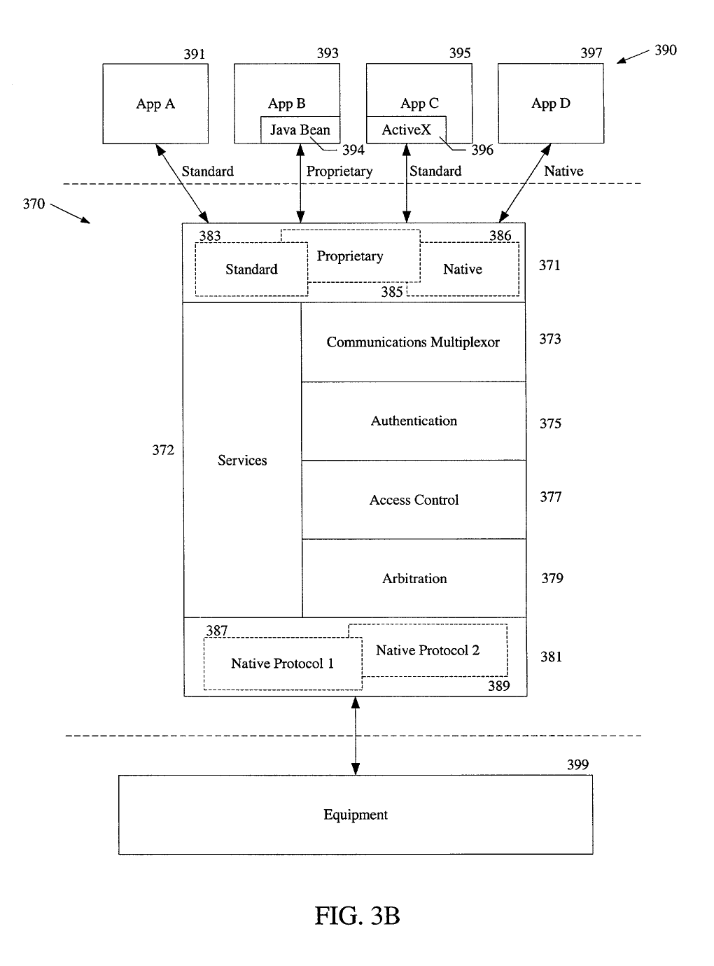

One embodiment of the invention is described by reference to FIG. 3A that illustrates an equipment facility 301, such as a semiconductor fabrication plant, that physically connects a host computer 305 to an equipment controller 307 in an equipment control system 303. An equipment application 319 executing on the host computer 305 typically communicates to the equipment controller 307 using messages formatted to a protocol specific to the architecture of the equipment control system 303, referred to hereinafter as “the control protocol.” The underlying transport protocol of the physical connections in the equipment control system 303 may also be a standard protocol such as TCP/IP or RS-232. Each connection in the facility 301 that transmits messages formatted according to the control protocol of the equipment control system 303 is illustrated in FIG. 3A as a thick arrow.

The equipment controller 307 is coupled to various pieces of equipment 311, 313 to monitor, and optionally control, the equipment as determined by equipment controller algorithms or as requested by the application 319. The equipment controller 307 relays equipment status information back to the application 319. Depending on the equipment, the controller 307 may also control the operation of the equipment 311, 313 as directed by the application program 319. The equipment 311, 313 generally understands only a specific or “native” application protocol which may be a standard protocol, such as SECS (Semiconductor Equipment Communications Standard), OPC (OLE for Process Control) or SNMP (Simple Network Monitoring Protocol), or a protocol proprietary to the equipment manufacturer, and is illustrated in FIG. 3A as a single line arrow. The native protocol may be based on either digital or analog signals.

Equipment controller 309 is also coupled to the equipment control system 303, but instead of being coupled directly to the pieces of equipment 315, 314, 317 it controls, the controller 309 is coupled to equipment servers 323, 325, each of which is a general purpose computer or specialized interface hardware executing equipment server software described in the next section. Each equipment server 323, 325 is responsible for passing messages between the equipment 315, 314, 317 and the controller 309 in the native protocol. Optionally, the equipment servers can communicate with the equipment controllers using the control protocol of the equipment control system 303, shown as a phantom arrow linking the equipment server 323 and the equipment controller 309.

The equipment servers 323, 325 are also capable of sending and receiving messages formatted in at least one non-native application protocol, such as IIOP (Internet Inter-ORB Protocol), XML (Extensible Markup Language), or a proprietary protocol through an equipment overlay network 321. Connections using the non-native application protocols of the equipment overlay network 321 are illustrated in FIG. 3A as double line arrows. While the equipment servers 323, 325 are coupled to existing equipment to enable the equipment to communicate with the equipment overlay network 321, new equipment may integrate the functions of the equipment server into the equipment, illustrated as server/equipment combination 327 in FIG. 3A. The server/equipment combination 327 connects to the equipment overlay network and to the equipment control system 303. If the server/equipment combination 327 is coupled directly into the equipment control system 303, it communicates in the control protocol. Alternatively, the server/equipment combination 327 may be coupled to an equipment controller to communicate in the native protocol of the equipment (shown as a phantom arrow linking the server/equipment combination 327 and the equipment controller 309).

In the embodiment shown in FIG. 3A, the equipment overlay network 321 is a separate, physical network from the equipment control system 303. In an alternate embodiment, the equipment overlay network 321 is a logical protocol layer executing on top of an existing physical equipment control system. The equipment overlay network 321 and the components connected to it define the architecture of the present invention. It will be appreciated that the control protocol of the equipment control system 303 could be later replaced with one or more of the non-native protocols used by the equipment overlay network 321 without affecting the architecture of the equipment overlay network. Furthermore, the server/equipment combination 327 can be connected into a new network having the characteristics of the equipment overlay network 321 described herein when no previous equipment control system 303 exists.

Because non-native application protocols are available on the equipment overlay network 321, an application 329, 331, 333 that uses one of the non-native application protocols can communicate with the equipment servers 323, 325 to access the equipment 315, 314, 317 through the equipment overlay network 321, even though the application does not understand the native application protocol used by the equipment. When applications 329, 331, 333 request information from the equipment 315, 314, 317, the equipment servers 323, 325 convert the request message from the non-native application protocol format into the native protocol format and transmit the converted request to the equipment 315, 314, 317. When the equipment servers 323, 325 receive the requested information from the equipment 315, 314, 317, the equipment servers 323, 325 convert the data message into the appropriate non-native application protocol format and send the converted message to the corresponding applications 329, 331, 333. When the equipment so provides, the equipment servers 323, 325 also convert control messages sent by the applications 329, 331, 333 to the equipment 315, 314, 317, allowing the applications 329, 331, 333 to control the equipment in addition to the applications 319 and the equipment controllers 307, 309. The applications 329, 331, 333 execute on one or more computers in the manufacturing facility 301 that are coupled into the equipment overlay network 321.

A supply chain community for an equipment facility consists of organizations and individuals who have an interest in the equipment and or its utilization. Exemplary supply chain community members include equipment users, equipment vendors, application providers, and companies that provide consumables, parts or services used by these groups. The equipment overlay network 321 also provides access to the equipment 315, 315, 317 (and server/equipment combination 327 described below) by appropriate supply chain community members. Applications executing on external computers, such as those operated by a manufacturer 355 of the equipment, a supplier 359 of consumables used by the equipment, or a services provider 363, such as a third-party software vendor, can remotely monitor and optionally, control the equipment 315, 314, 317, 327 through the equipment overlay network 321. As illustrated in FIG. 3A, the equipment overlay network 321 is coupled to a services coordinator computer 351 through a communications link 353.

The communications link 353 can be a point-to-point, dedicated connection or can be through a public wide-area network (WAN) such as the Internet or a VPN. FIG. 3A also shows an optional firewall 335 logically coupled between the communications link 353 and the equipment overlay network 321 to protect the integrity of the facility 301 when the communications link is a public WAN. Further, for the purpose of processing communications or providing summary or otherwise filtered, analyzed or processed data, an optional computer or computers may be logically coupled between the communications link 353 and the overlay network 321 and/or between the equipment 315, 314, 317, 327 and the services coordinator 351 to provide access control.

The illustrated supply chain members, consumables supplier 359, equipment manufacturer 355, and services provider 363, connect to the services coordinator 351 through various types of communications links, such as a T1 or DSL connection to the Internet 361, a direct dial-up connection 357, or a secured network 365 such as an intranet or VPN. The service coordinator 351 provides information technology and other services facilitating collaboration and exchanges between supply chain community members, such as collaboration and document sharing over a network, application leasing and sales, monitoring of application licensing and usage, billing and payment transaction services, application and network management, enterprise system integration, and logistics and transportation services.

In one embodiment, the services coordinator 351 performs authentication on the consumables supplier 359 and equipment manufacturer 355 before passing their messages to the equipment overlay network 321. If so configured, the equipment servers 323, 325 also evaluate the messages from the consumables supplier 359 and equipment manufacturer 355 against their access control parameters, providing yet another layer of security.

Although not illustrated, one of skill in the art will immediately conceive of alternate embodiments in which the consumables supplier 359, equipment manufacturer 355 and/or services provider 363 connect directly to the firewall 335. Such alternate embodiments are contemplated as being within the scope of the invention.

Applications on the external computers for the consumables supplier 359, equipment manufacturer 355 and services provider 363 can issue requests and commands that are then processed by the equipment servers 323, 325 and relayed to the equipment 315, 314, 317, 327. In another embodiment, the applications on the external computers cause applications 329, 331, 333 to act on their behalf, and such external and internal applications may be designed to operate together as a single application. For example, the consumables supplier 359 can request that application 329 perform a series of operations to determine the amount of various consumables remaining on equipment 315 and return all the amounts in a single message. Various application program interfaces (APIs), including browser plug-ins, XML, and Java applets, can provide the necessary external access to the applications 329, 331, 333, and are considered within the scope of the invention. In yet another embodiment not shown, the supply chain community member maintains its own computer system within the facility 301 that it controls through the equipment overlay network 321. This computer system may be logically inside or outside the protection of the optional firewall 335.

Because the consumables supplier 359 can monitor the level of consumables, the consumables supplier 359 can alert the appropriate person at the facility when supplies are low. Using the embodiment shown in FIG. 3A, the consumable can then be reordered through the services coordinator 351, which passes the order through to the consumables supplier 359. In another embodiment, an order can be automatically generated in response to the message from the consumables supplier 359 and sent to the services coordinator 351, which can check it for accuracy, etc., before passing it through. Similarly, by allowing the equipment manufacturer 355 access and control over the equipment, the equipment manufacturer 355 can run diagnostics tests and adjust the operation of the equipment for maximum efficiency.

The services coordinator 351 not only enables the consumables supplier 359 and equipment manufacturer 355 access to the equipment so they can provide better service to the facility, but it also acts as a distribution channel for new or updated applications for the equipment. For example, an application update is uploaded from the services provider 363 to the services coordinator 351. The services coordinator 351 can check the software for viruses or other problems before downloading the application to the various facilities that subscribe to an update service for the application.

Through the services coordinator 351, one application can interact with equipment located at multiple sites, including sites with differing control systems without requiring specific integration into multiple control systems. The services coordinator 351 also coordinates between different supply chain members, with differing interests that create and deploy applications independently of each other. The services coordinator 351 can host applications on behalf of each party and provide common services, greatly reducing the system integration and administration costs for the supply chain members.

It will be appreciated that the consumables supplier 359, equipment manufacturer 355 and services provider 363, i.e., the supply chain members, may be regarded as business partners of the services coordinator 351, and that the services coordinator 351 may require compensation from its business partners for providing the services described above and other related services on their behalf. Various compensation methodologies can be employed by the services coordinator 351 based on the type of service provided, the frequency of the service, the number of facilities subscribing to the service, etc.

For example, the services coordinator 351 may receive revenue for the following services.

1. Providing communications and/or networking with the equipment. Revenue models may include set-up and installation, monthly service charges, and fee peruse. Various billing models may be used, including flat-rate per site, flat-rate per unit of equipment, fee for amount of data transmitted, “one-time” charges for configuration changes.

2. Serving as a “Value-added reseller” or distributor for applications. As a value added reseller, interfaces would be provided to provide communication with the equipment, thereby linking the equipment and the application(s). The services coordinator would license use of the application to other supply chain community members and remit to application providers. Revenue models may include the service coordinator licensing the application outright from the application providers and providing access to the application to others (and receiving revenue from providing said access), purchasing and re-licensing the application (with a gross margin on the transaction), or passing-through the application license.

3. Providing application integration, administration and configuration services.

4. Providing application upgrade and maintenance services.

5. Handling transactions, e.g., purchase of replacement parts, for the supply chain community members, including passing the information for the transaction to the supply chain community members without taking title to the product(s), or taking title to and reselling product(s).

It will be further appreciated that a supply chain member, such as equipment manufacturer 355, may act as the services coordinator 351 for its own products and services and is therefore is not directly compensated for the coordination services. Instead, the supply chain member receives indirect compensation through other products and services that it provides, or through the reduction in its costs of providing such products and services when it acts as the services coordinator 351.

In the embodiment shown in FIG. 3A, the equipment servers 323, 325 are physical devices external from the existing equipment 315, 314, 317 and are coupled to the equipment through the existing connection for the equipment control system 303. Because the equipment servers 323, 325 provide the functions described above, they can be used to retrofit existing equipment into the equipment overlay network 321. Additionally, the equipment server software that provides the functions is envisioned as being incorporated into new equipment as illustrated by the server/equipment combination 327 in FIG. 3A. One of skill will appreciate that the functions of the equipment server can also be performed by dedicated firmware.

Also, as illustrated in FIG. 3A, not all equipment in a facility must be coupled into the equipment overlay network 321. Equipment on one controller can continue to be “natively” coupled to the controller as described above for controller 307 and equipment 311, 313, while equipment on another controller, such as controller 309, is coupled to the controller through equipment servers. Moreover, one piece of equipment can be retrofitted with an equipment server while another piece of equipment on the same controller can remain natively coupled to the controller.

Turning now to FIG. 3B, one embodiment of the equipment server of the present invention is described in detail. Equipment server 370 is logically located between applications 390 and equipment 399, and incorporates seven functions: an application interface 371, a services module 372, a communications multiplexor 373, an authentication function 375, an access control function 377, an arbitration function 379, and an equipment interface 381. The application interface 371 and the equipment interface 381 operate in concert to convert between native and non-native protocols.

The application interface 371 is responsible for communicating with the applications 390 and contains one or more non-native application protocol modules, which may be a standard protocol module 383 or a proprietary protocol module 385 or a combination as shown in FIG. 3B. The application interface 371 can also contain a native protocol module 386 in addition to the non-native protocol modules. Thus, as shown in FIG. 3B, the application interface 371 processes inbound messages from application A 391 using a standard protocol module 383 and those from application B 393 and application C 395 using a proprietary protocol module 385. The protocol modules unpack the contents of the inbound message for further processing by the other functions in the equipment server 370. The message will be converted into a command in the native protocol by the equipment interface 381 after the further processing is complete. The protocol modules in the application interface 371 also package data returned from the equipment 399 in response to a request from an application 390 into an outbound message formatted with the appropriate non-native protocol. The content of a message from application D 397 is unpacked by the native protocol module 386.

The equipment server 370 also processes notification messages originating from the equipment 399 (such as alarm, event, and trace notifications) using the native protocol 387 or 389. The appropriate native protocol in the equipment interface 381 unpacks the contents of the outbound message for further processing by the other functions of the equipment server 370. The notification message may then be passed directly to the communications multiplexor 373 for transmission to one or more applications through the application interface 371, or passed to the services module 372 for further processing. The communications multiplexor 373 and the services module 372 are described further below.

FIG. 3B also illustrates two software components, a Java Bean 394 in application B 393 and an ActiveX control 396 in application C 395. Such software components are written by the application developer or generated by a development system associated with the present invention as generalized interfaces to the equipment server. The appropriate component is embedded in an application to provide the necessary communication with the equipment server, eliminating the necessity of creating a specific interface for each application.

The equipment server 370 provides various general functions commonly required by the applications 390, such as tracing, limits monitoring, caching, spooling, alarm and event management and equipment subsystem management, through the services module 372. When the request for a general function provided by the services module 372 requires communication with the equipment, the services module 372 sends one or more commands to the equipment to carry out the function. If the inbound message is not requesting one of the generalized services, the message contents are passed immediately to the communications multiplexor 373. As described above, the services module 372 may also provide general services needed by outbound messages, such as a name service to notify applications that the equipment has come on-line and can be used. Further functions can be incorporated into the services module 372 that provide data to the equipment when requested, such as a recipe for wafer production.

Requests for concurrent access to the equipment 399 are managed by the communications multiplexor 373 to permit the sharing of a single piece of equipment among multiple applications. The communications multiplexor 373 ensures that all commands from the applications 390 are communicated to the equipment 399 and that all messages from the equipment 399 are addressed to the appropriate application(s) 390.

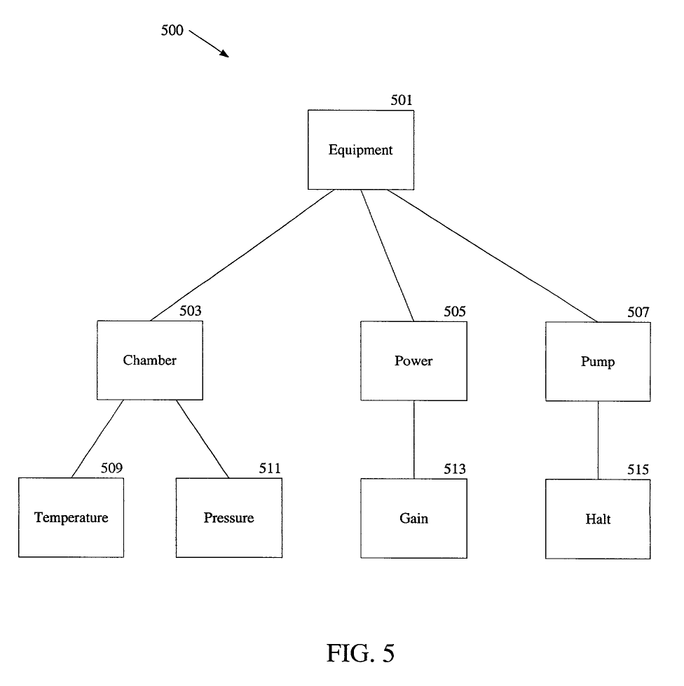

The equipment server 370 provides two types of security for the equipment: authentication and access control. The authentication function 375 verifies the legitimacy of the inbound message using conventional authentication methodologies. The access control function 377 controls access to the equipment 399 from the applications 390. The access control function 377 may be parameterized so that a facility administrator can choose the appropriate level of security desired. For example, the equipment server 370 can deny access to equipment 399 by application, user, equipment resource, time, or a combination of these parameters. A particular implementation of the access control function that provides for a finer granularity of security is described further below in conjunction with FIG. 5.

The arbitration function 379 arbitrates between requests and commands sent to the equipment 399 from the applications 390 to prevent multiple conflicting or unacceptable requests from being received simultaneously by the equipment. In addition, the arbitration function 379 arbitrates between conflicting commands by either ordering the commands appropriately, by submitting only one command to the equipment and returning an error to the applications that issued the other commands, or through the use of wait queues. A detailed description of an implementation of the arbitration function 379 is provided further below.

The equipment interface 381 communicates to the equipment 399. As described above, the equipment interface 381 converts inbound messages in a non-native protocol into the appropriate equipment command. As illustrated in FIG. 3B, the equipment interface 381 contains two native equipment protocol modules, native protocol 1 387 and native protocol 2 389. More than one native protocol module may be needed when different types of equipment are controlled by the equipment server 370. Alternatively, one piece of equipment may be able to communication in more than one native protocol. The appropriate native protocol module unpacks the message returned by the equipment 381 and passes the contents back to the other functions in the equipment server 370. The message is then converted as necessary by the application interface 371.

An alternate minimal embodiment of the equipment server 370 provides only three functions: the application interface 371, the communications multiplexor 373, and the equipment interface 381. Other embodiments combine the minimal functions and the remaining functions in various combinations.

Given the architecture of the equipment server 370, it will be appreciated that implementing a new application with a different non-native application protocol merely requires incorporating an appropriate application protocol module into the application interface 371 for the equipment servers that will handle requests from the new application. Similarly, attaching a new piece of equipment with a different native protocol to an existing equipment server also only requires incorporating an appropriate equipment protocol module into the equipment interface 381.

The overview of one embodiment of the equipment overlay network architecture according to the present invention has been described in this section of the detailed description. The network overly architecture enables equipment to be concurrently accessed by multiple applications using native and non-native application protocols. The equipment overlay network architecture further allows access to the equipment to be shared across facility, organizational and geographic boundaries. While the invention is not limited to implementation in any particular type of facility, for sake of clarity a simplified manufacturing equipment control system has been used to illustrate the operations of the equipment overlay network architecture.

### Methods of Embodiments of the Invention

In the previous section, an overview of one embodiment of the equipment overlay network architecture of the invention was described. In this section, the particular methods of the invention are described in terms of computer software with reference to a series of flowcharts. The methods to be performed by a computer constitute computer programs made up of computer-executable instructions. Describing the methods by reference to a flowchart enables one skilled in the art to develop such programs including such instructions to carry out the methods on suitably configured computers (the processor of the computer executing the instructions from computer-readable media). If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

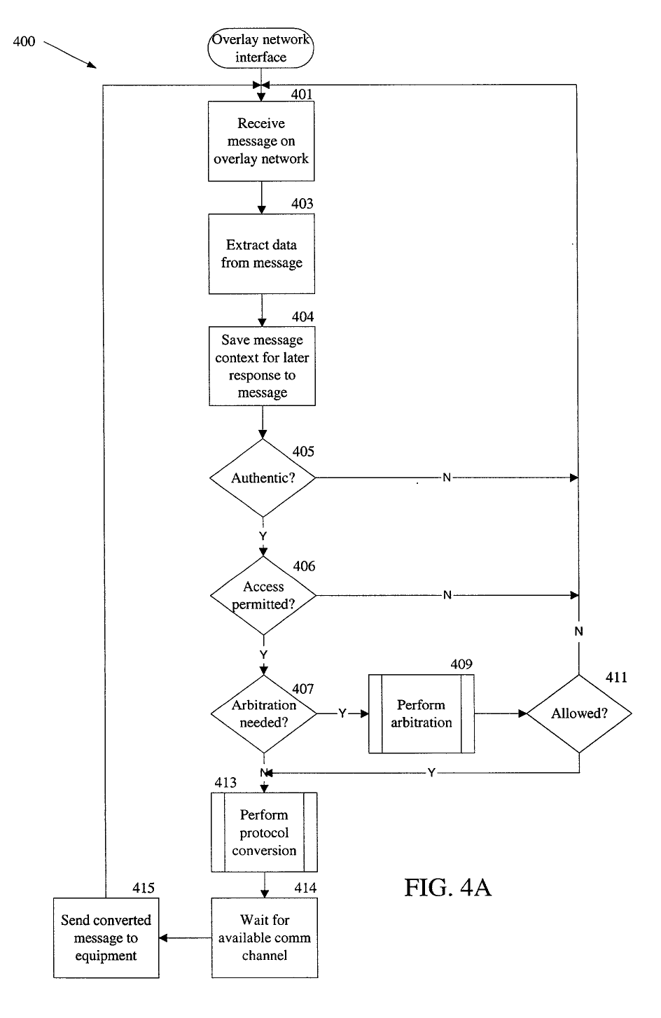

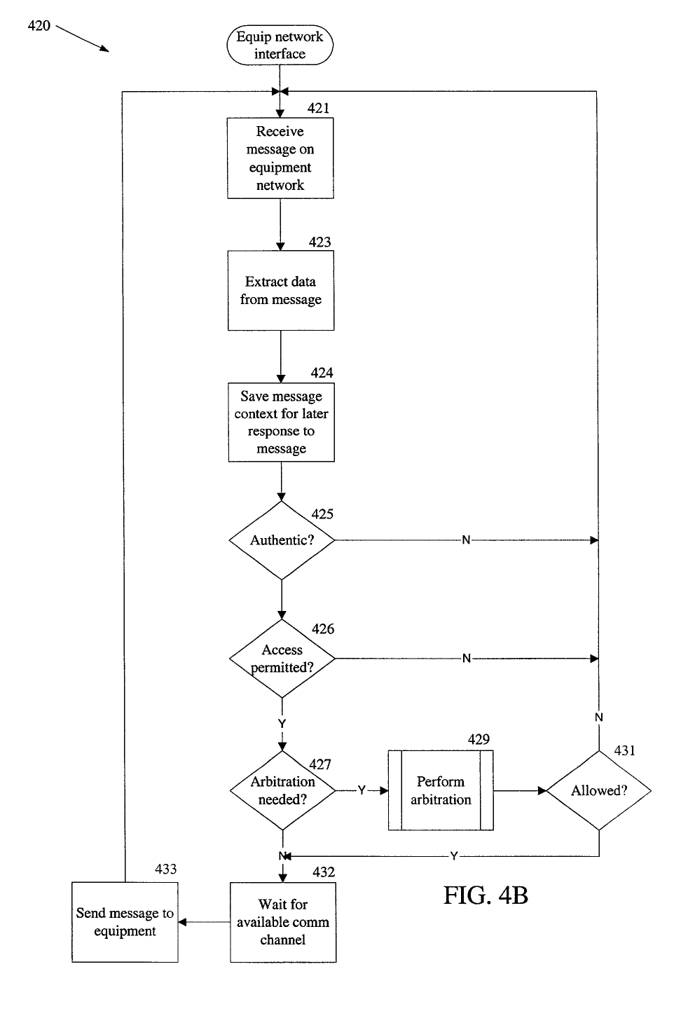

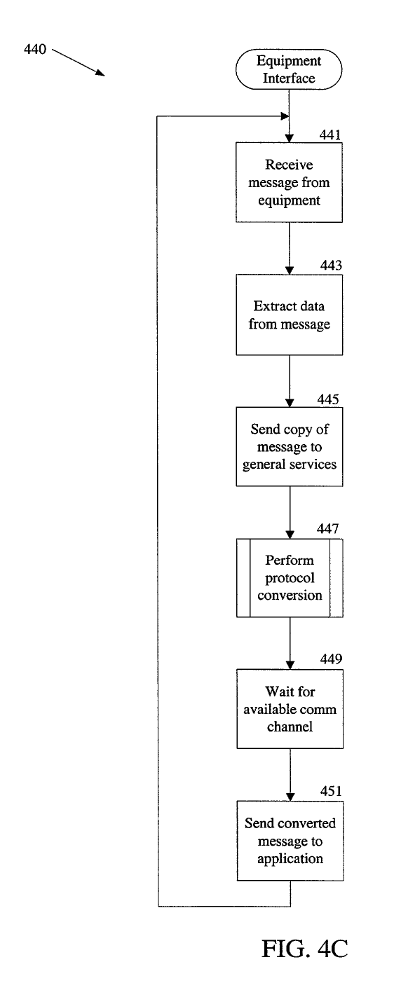

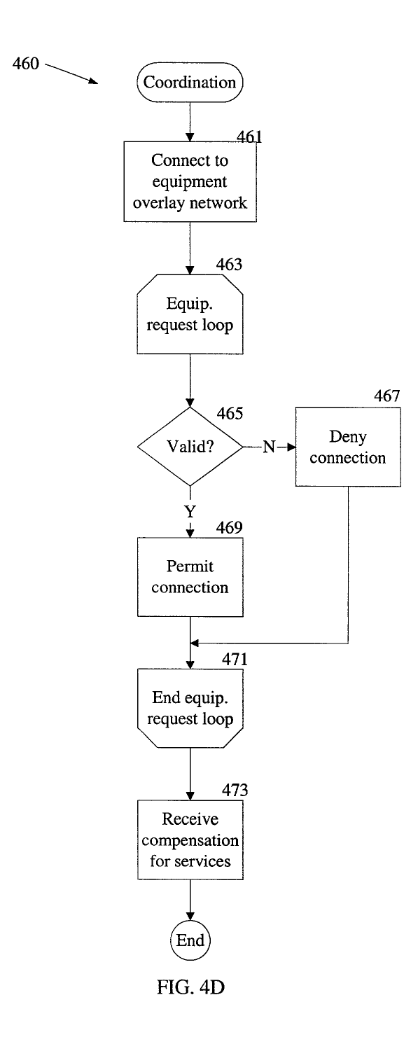

FIGS. 4A-C represent the acts to be performed by an equipment server 323, 325 or by a server/equipment combination 327 in handling messages in both native and non-native protocols. FIG. 4A illustrates one embodiment of an interface process that handles messages from an application through the equipment overlay network. FIG. 4B illustrates one embodiment of an interface process that handles messages from an application through the equipment control system. FIG. 4C illustrates one embodiment of an interface process that handles messages from the equipment. Multiple instances of the methods illustrated in FIGS. 4A-C may be active to handle multiple messages, and the instances of one method or those of different methods may performed in parallel by the equipment server hardware when necessary.

Referring first to FIG. 4A, when the equipment server receives a message on the equipment overlay network (block 401), the interface method 400 extracts the data from the message for analysis (block 403) and saves the context of message (block 404). The context is used to generate a correct protocol header in the response, e.g. including a message identifier for the original message, when responding to the message. An appropriate authentication algorithm is performed on the message and the message is discarded if it cannot be validated (block 405). Similarly, if the data is a request for access to the equipment that is not permitted under the security parameters (block 406), the message is discarded. Alternatively, an error message can be returned to the application program that sent the message that cannot be authenticated or is denied access. The services module may also log the error or take some other action.

Assuming the message is authenticated and access is permitted, the method 400 determines whether the data request is subject to arbitration (block 407) because other applications are concurrently accessing the equipment. If so, an arbitration process is performed at block 409. In one embodiment, the arbitration process determines if there is contention between the message and other applications. A message that is in contention with other application is either queued for later processing, or denied access to the equipment. A message that is denied access (block 411) is discarded and an error message can optionally be returned to the sending application. As described above, the error also may be passed to the services module for additional processing. If there is no contention with other messages, or when a message is released from a queue, the message is passed to a protocol conversion process (block 413) that converts the message to the native protocol of the equipment. The method 400 waits until a communications channel to the equipment becomes available (block 414) and then sends the converted message to the equipment (block 415). Because authentication, access control and arbitration are optional functions for the equipment server, alternate embodiments of the overlay network interface method 400 do not execute one or more of the processes represented by blocks 405, 406, 407, 409 and 411.

A similar interface method 420 is provided to receive messages through the equipment control system in the native protocol as shown in FIG. 4B. After the message is received (block 421), the data is extracted (block 423) and saved (block 424). Any required security (authentication and access control) and/or arbitration analysis is performed at blocks 425, 426 and 427-431, respectively. The arbitration process at block 429 is the same as performed at block 409 in FIG. 4A. Assuming the message is allowed access to the equipment, it is passed directly to the equipment without conversion (block 433) since it is already in the native protocol of the equipment when a communications channel is available (block 432).

Turning now to FIG. 4C, the acts comprising a method 440 that provides an interface to the equipment is described. When a message is received from the equipment (block 441), the interface method 440 extracts the data from the message (block 443) and sends a copy of the message to the general services (block 445) for further processing as described above. If necessary, the method 440 converts the message from the native protocol of the equipment to the non-native protocol corresponding to the application to which the message is addressed (block 447). When a communications channel to the application is available (block 449), the converted messaged is transmitted to the application on the equipment overlay network (block 451).

The particular methods performed by a computer acting as an equipment server according to one embodiment of the invention have been described. The method performed when receiving a message from the equipment overlay network has been shown by reference to a flowchart in FIG. 4A including all the acts from 401 until 415, the method performed when receiving a message from the equipment control system has been shown by reference to a flowchart in FIG. 4B including all the acts from 421 until 433, and the method performed when receiving a message from the equipment has been shown by reference to a flowchart in FIG. 4C including all the acts from 441 until 451. It will be apparent that the computer that executes these methods may be a general purpose computer, or may be hardware specifically designed to act as an equipment server without departing from the scope of the invention.

FIG. 4D illustrate the acts to be performed by a services coordinator, such as services coordinator 351 in providing information technology and other services that facilitate collaboration and exchanges between supply chain community members. A coordination method 460 couples the services coordinator to one or more equipment overlay networks to which the services coordinator provides access (block 461). An equipment request loop starting at block 463 and terminating at block 471 is performed for each equipment access request made by a supply chain member for access to a piece of equipment on the equipment overlay network. It will be appreciated that the equipment request loop may be invoked when the method 460 receives an equipment access request or it may be invoked immediately upon successful connection to the equipment overlay network and remain idle until an equipment access request is received. For each equipment access request, the method 460 determines if the request is valid, such as checking the authority of the supply chain member to access the piece of equipment, checking the integrity of any data to be transferred to the piece of equipment, obtaining any permissions for access to equipment or equipment data required from the owner or user of the equipment, etc. (block 465). If the request is not valid, connection to the equipment overlay network is denied and a error message may be sent to the supply chain member explaining the reasons for denying the access (block 467). If the request is valid, the supply chain member is permitted to connect to the equipment overlay network to perform its work (block 471). One of skill in the art will immediately understand that the method 460 may monitor all communication between a supply chain member and an equipment overlay network, or may only monitor the initial connection for validity.

In the embodiment shown in FIG. 4D, the method 460 also receives compensation for providing the services at block 473. It will be appreciated that the compensation can be received at any point in the process or may be received by an entirely separate process without departing from the scope of the invention.

### Symphony Systems Implementation

This section describes a particular implementation of the arbitration and access control functions used in equipment servers produced by Symphony Systems, assignee of the present invention.

Arbitration

Most equipment is controlled by a hardware front panel. Equipment that does allow multiple applications front panel access to the equipment does not adequately address contention control issues that cause interference among applications. For example, if one application tells the equipment to move a robot arm forward at the same time as another application requests the equipment to move the robot arm backward, the outcome is indeterminate. Software applications that require contention control include systems to log trending data to a database, send alarms on unusual conditions of a piece of equipment, and run diagnostics on the equipment.

The arbitration function in a Symphony System equipment server allows applications to request exclusive access to the resource, thereby eliminating the problem of applications interfering with each other. Additionally, applications may share a resource when doing so will not adversely impact usability or operation. For example, two applications might safely both request simultaneous access to an equipment temperature reading resource. Provisions are made to allow applications to wait for a resource to free up. Furthermore, an application is allowed to take control of a resource if the application has sufficient priority.

Resources represent a set of controls or indicators of an element that advertises its resources. A resource may represent a property, command, trigger, event handler, or event generator. All resources are mutually exclusive. Applications may request a set of resources, where the request is granted only if all the resources are available. Resource contention is particularly useful where the resources are distributed across a computer network. For example, a piece of manufacturing equipment could have a set of resources such as controls and indicators that could simultaneously be accessed by the equipment operator, the floor foreman, and the front office management.

An application requests some type of access to a resource. Assuming appropriate privilege, the equipment server may grant the access, subject to contention control. Access may be implicitly requested when an application, such as a remote front panel application, is instantiated or the application may request access explicitly in response to some event. For example, a master “disable” button could request exclusive access to the “go” command.

The types of access that may be granted are (1) read, (2) write, (3) exclusive read, and (4) exclusive write. The “read” and “exclusive read” access privileges are independent from the “write” and “exclusive write” privileges. Multiple applications may be granted “read” and/or “write” privileges, but if an application is granted exclusive access for reading, no other applications may have either exclusive read access or read access. Similarly, if an application is granted exclusive write access, no other applications may have either exclusive write access or write access.

If a requested resource has already been “taken” by another application, that is, if the other application has already been granted exclusive access, the equipment server will perform one of two actions: (1) if the requesting application has a higher priority than the current owner of the resource, the current owner will be “bumped”, that is to say access privileges will be forcibly taken away from the current owner, and given to higher priority application, or (2) if the requesting application is of equal or lower priority, the requesting application will be placed on a wait queue.

Each resource has a wait queue associated with each of the four types of access: (1) read queue, (2) write queue, (3) exclusive read queue, and (4) exclusive write queue. The read and write queues are of unlimited depth. The exclusive read and exclusive write queues are one deep, that is there can be at most one application on an exclusive queue.

Applications are placed on the read queue when read access is requested to a resource which already has been given to another application for exclusive read access. Similarly, applications are added to the write queue when write access is requested to a resource which already has been given to another application. In addition, any applications that have read or write access and are bumped in response to another application's higher priority request for exclusive access are placed on the read or write queues, respectively.

Applications are placed on the exclusive read or exclusive write queue when they request exclusive access to a resource and that resource has already been claimed for exclusive access by an equal or higher priority application and any application already on the respective exclusive queue is of equal or lower priority.

When an application releases a resource from its exclusive use by the application, the equipment server performs one of two actions: (1) if the exclusive queue has an application of higher priority that any and all applications on the non-exclusive queue, exclusive access is granted to the application on the exclusive queue, and the application is removed from the exclusive queue, or (2) if the exclusive queue is empty or is of lower priority than any application on the non-exclusive queue, non-exclusive access is granted to all applications on the non-exclusive access and they are all removed from the non-exclusive queue.

When an application releases a resource from its non-exclusive use of a resource and there is an application on the exclusive queue of higher priority than any and all of the remaining non-exclusive use application, the remaining applications are all bumped, that is, they are forcibly denied further access and are placed on the non-exclusive queue, and the exclusive access is granted to the higher priority application on the exclusive queue.

An application may request multiple resource in either of the following two ways: (1) claim all available resources, or (2) claim multiple resource only if all resources are available. When claiming all available resources (option 1), each resource is requested independently, subject to the contention process described above. When using option 2, if all the resources are available, access is granted to each of the resources. If any resource is not available, the application is placed on the wait queues for the unavailable resources, but access is not granted to the available resources in order to avoid potential deadlock on the resources. When a resource frees up, and an application on a wait queue is waiting for all resources of a requested set to be available, the request is re-evaluated in the same manner as the original request.

The contention model and algorithms provide an effective and innovative solution allowing access to a set of resources. The priority based scheme allows maximal use of the resource while still allowing a sufficiently privileged application to gain access at any time. The queuing structure adds high ease-of-use, allowing applications to gain access as soon as a resource is freed, relieving the application of the need to poll periodically to determine if the resource is available.

Access Control Security

The access control function in a Symphony Systems equipment server is based on a security model that segments the equipment into a hierarchy of subsystems, and provides fine-grained access control at each subsystem level. For example, a piece of equipment might be divided into subsystems as shown in FIG. 5. Each logical node in the hierarchy has its own access control, so that one application could have access to Equipment.Chamber.Temperature, but no access to Equipment.Power.Gain.

Each non end-node in the hierarchy represents a directory of sub nodes (subsystems). Each end-node may represent a sensor that can be read, a control that may be set, a software setting that effects processing, a function to be executed on the equipment, enabling and/or subscribing to an equipment alarm or equipment event. The access control may or may not be cumulative in protecting access to the equipment. Thus, access control may be implemented that restricts access to Equipment.Chamber and to any sub-nodes, or may be implemented where each end node contains complete information about its access.

The access control information for a level is stored in an access control list. The access control list specifies read access, write access, administrative access, access to alarms, access to events, permission to execute functions on the equipment, or permission to modify the access control list for the node, or a combination thereof. For example, a monitoring application might have read-only access to the entire equipment, while a feedback control mechanism would have read and write access to a single equipment subsystem.

The security provision of the hierarchy may be used for direct access to the subsystems and end-nodes, as well as for aggregated access to the nodes through services provided by the equipment server, such as:

Limits monitoring, where a client application specifies the limits of the value of a node, and asks to be notified if the node becomes outside of the limits. The ability to monitor the limits of the node would depend on access rights to the node.

Trace monitoring, where an applications requests that it be notified periodically of the value of one or more nodes. The ability to set up the trace would depend on the access rights to each of the nodes requested for tracing.

Access to sets of variables, where a single request for a set of (possibly consistent) values of nodes is made. The access request is subject to the access permitted to each reference node. If access is not permitted to every referenced node, the request could either be rejected in its entirety, or be partially fulfilled by returned results for which the client application does have access.

Creation of “software agents,” whereby a client application provides application or business logic to monitor or control the equipment. The agent software would reference one or more nodes, and access to the referenced nodes in the logic would be subject to this hierarchical access control.

Each equipment manufacturer could create an unchangeable segmentation model for its equipment, thus aiding in supportability of the equipment. Alternatively, the equipment manufacture or a third-party could create a segmentation model that is changeable by the enduser of the equipment to provide additional flexibility. Furthermore, the equipment manufacturer may set access control for particular nodes to prevent modification of the access control parameters or topology, thus enabling some nodes of the equipment to be accessible only by the equipment manufacturer, while permitting configuration of the access control lists of other nodes. For example, sensitive equipment parameters might only be accessible by the equipment manufacturer.

### Conclusion

A services coordinator manages access to equipment through an equipment overlay network to link people, equipment and global resource management into a powerful supply chain community. For example, equipment manufacturers could be use the services coordinator to provide customer support, including remote diagnostics and service, or to sell value-added services. In another instance, application providers could use the services coordinator to distribute their applications.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Those of ordinary skill within the art will appreciate that while the equipment overlay network architecture has been described in terms of a manufacturing facility, the invention is not so limited. For example, the equipment could include automated capital equipment (such as semiconductor processing and metrology equipment, computer numerical controlled machine tools, analytical instruments, telecommunications transmissions equipment, etc.), other industrial equipment (such as gasoline pumps, electrical and power transmission systems, building control systems), or new “network appliances,” for example home sprinkler systems.

The terminology used in this application with respect to the equipment overlay network architecture is meant to include all of these environments and the various protocols inherent in those environments. Therefore, it is manifestly intended that this invention be limited only by the following claims and equivalents thereof.

What is claimed is:

1. A method of providing access for a supply chain member to a piece of equipment:
coupling a services coordinator to an equipment overlay network to coordinate the access to the piece of equipment, the equipment overlay network including an equipment server coupled to the piece of equipment to manage concurrent communications with the piece of equipment; and
coupling the supply chain member to the services coordinator to communicate with the piece of equipment through a first application coupled to the equipment server.

2. The method of claim 1 further comprising:
receiving compensation by the services coordinator from the supply chain member.

3. The method of claim 1 further comprising:
specifying the supply chain member as the services coordinator.

4. The method of claim 1, wherein coupling a services coordinator to an equipment overlay network comprises:
coupling the services coordinator to a remote connection on the equipment overlay network.

5. The method of claim 1 further comprising:
coupling the first application to the equipment server through the services coordinator.

6. The method of claim 1 further comprising:
coupling a second application to the equipment overlay network through the services coordinator to control the first application.

7. The method of claim 1, wherein the supply chain member is chosen from the group consisting of equipment manufacturers, consumables suppliers and services providers.

8. The method of claim 1, wherein the services coordinator receives compensation for providing a service chosen from the group consisting of equipment communication, application distribution, application integration, application administration, application configuration, application upgrading, application maintenance, and transaction management.

9. The method of claim 1 further comprising:
supplying the equipment server.

10. The method of claim 1 further comprising:
supplying the equipment overlay network.

11. A computer-readable medium having executable instructions to cause a processing unit to execute a method comprising:
coupling a services coordinator to an equipment overlay network, the equipment overlay network including an equipment server coupled to the piece of equipment to manage concurrent communication with the piece of equipment; and
coupling the supply chain member to the services coordinator to communicate with the piece of equipment through a first application coupled to the equipment server.

12. The computer-readable medium of claim 11, wherein the method further comprises:
receiving compensation by the services coordinator from the supply chain member.

13. The computer-readable medium of claim 11, wherein the method further comprises:
specifying the supply chain member as the services coordinator.

14. The computer-readable medium of claim 11, wherein coupling a services coordinator to an equipment overlay network comprises:
coupling the services coordinator to a remote connection on the equipment overlay network.

15. The computer-readable medium of claim 11, wherein the method further comprises:
coupling the first application to the equipment server through the services coordinator.

16. The computer-readable medium of claim 11, wherein the method further comprises:
coupling a second application to the equipment overlay network through the services coordinator to control the first application.

17. A computer system comprising:
a processing unit;
a memory coupled to the processing unit through a bus;
a network interface coupled to the processing unit through the bus and operable for coupling to an equipment overlay network that includes an equipment server coupled to a piece of equipment to manage concurrent communication with the piece of equipment over the equipment overlay network; and
a coordination process executed from the memory by the processing unit to cause the processing unit to couple to the equipment overlay network and to further couple a supply chain member to the equipment overlay network to communicate with the piece of equipment through a first application coupled to the equipment server.

18. The computer system of claim 17, wherein the coordination process further causes the processing unit to receive compensation from the supply chain member.

19. The computer system of claim 17, wherein the coordination process further causes the processing unit to specify the supply chain member as the services coordinator.

20. The computer system of claim 17, wherein the coordination process further causes the processing unit to couple to the equipment overlay network through a remote connection on the equipment overlay network.

21. The computer system of claim 17, wherein the coordination process further causes the processing unit to couple the first application to the equipment server through the equipment overlay network.

22. The computer system of claim 21, wherein the coordination process further causes the processing unit to couple a second application to the equipment overlay network to control the first application.
